(19) United States
(12) Patent Application Publication
(10) Pub. No.: US 2007/0025226 A1
(43) Pub. Date: Feb. 1, 2007

(54) Phase change memory device and method of manufacturing the same

(76) Inventors: Young Sam Park, Gyeonggi-do (KR); Sang Ouk Ryu, Daejeon-city (KR); Sung Min Yoon, Daejeon-city (KR); Nam Yeal Lee, Daejeon-city (KR); Kyu Jeong Choi, Daejeon-city (KR); Seung Yun Lee, Daejeon-city (KR); Byoung Gon Yu, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/490,405

(22) Filed: Jul. 20, 2006

(30) Foreign Application Priority Data
Jul. 29, 2005 (KR) 10-2005-0069803

(51) Int. Cl. G11B 7/00

(52) U.S. Cl. 369/100

(57) ABSTRACT

Provided are a phase change memory device and a method of fabricating the same capable of maximizing a contact area of a phase change layer and a heating electrode. The memory device includes a heating electrode and a phase change layer. The heating electrode covers at least one side exposed by a pore and a portion of a surface of a lower electrode and includes a recess region. The phase change layer is stacked on the heating electrode filling up the recess region. The memory device may maximize a contact area of the phase change layer and the heating electrode, thereby greatly reducing power consumption.

### CROSS-REFERENCE TO RELATED PATENT APPLICATION

This application claims the benefit of Korean Patent Application No. 10-2005-0069803, filed on Jul. 29, 2005, in the Korean Intellectual Property Office, the disclosure of which is incorporated herein in its entirety by reference.

### BACKGROUND OF THE INVENTION

1. Field of the Invention

The present invention relates to a phase change memory device and a method of fabricating the same, and more particularly, to a phase change memory device limiting heat necessary for a phase change and a method of fabricating the same.

2. Description of the Related Art

With the increase in demand for data storage devices, memory devices for storing large amounts of information are required. Therefore, there is a need for a new device having the properties of a flash memory device, such as high integration, non-volatility, and low power consumption, as well as maintaining the advantages of a dynamic random access memory (DRAM). A magnetic RAM (MRAM) and a ferroelectric RAM (FRAM) have been developed, but are expensive for the amount of memory capacity they possess. On the other hand, the phase change memory device is emerging as a new type of memory device, due to the fact that it is easily integrated and may be reduced in size without degradation in material properties.

A main phase change material used for the phase change memory device, for example, chalcogenide, has excellent phase change properties in a conventional optical disc such as a compact disc rewritable (CD/RW), a digital versatile disc rewritable (DVD/RW), etc. Also, the chalcogenide is suitable for a conventional process of fabricating a silicon device, so that a high-density integrated device can be easily fabricated using the chalcogenide at an integration level equal to or higher than that of DRAM. Furthermore, since the phase change memory device has a relatively simple stacked structure, it is easy to manufacture, and the fabricating method used is simple. Thus the size of a cell can be largely decreased compared to a conventional memory device. Accordingly, the phase change memory device has a merit of decreasing a fabrication cost for its amount of memory capacity compared to the MRAM and the RFAM.

The phase change memory device uses a difference in resistance of the phase change material. Specifically, a crystal state (low resistance state) and an amorphous state (high resistance state) of the phase change material are controlled using Joule heat generated by a current flowing through a resistor. FIG. 1 is a cross-sectional view of a conventional phase change memory device.

Referring to FIG. 1, a lower electrode 12 and a heating electrode 14 are stacked on a substrate 10. An insulating layer 16 is patterned on the heating electrode 14, and a pore 18, that is, an opening, is formed in the insulating layer 16. A phase change layer 20 is filled into the pore 18 and is stacked on the heating electrode 14. An upper electrode 22 is located on the phase change layer 20.

The phase change memory device uses the Joule heat for the device operation, and thus may inevitably consume a large amount of power. Therefore, power consumption should be reduced in order to be able to practically use the phase change memory device. Here, when the phase change memory device is fabricated using a conventional method of fabricating a memory device with a large design rule, a current and a heat exceeding the tolerance limit are generated from the overall phase change memory device. However, as the design rule has been reduced, the phase change memory device fabricated with a smaller design rule has a smaller size. Thus, the power consumption for operating the phase change memory device can be greatly reduced. In addition, a contact area of the phase change layer 20 and the heating electrode 14 may be enlarged to reduce power consumption.

### SUMMARY OF THE INVENTION

The present invention provides a phase change memory device capable of maximizing a contact area of a phase change layer and a heating electrode.

The present invention also provides a method of fabricating a phase change memory device capable of maximizing a contact area of a phase change layer and a heating electrode.

According to an aspect of the present invention, there is provided a phase change memory device including a lower electrode and an insulating layer covering at least one surface of a lower electrode and including a pore that exposes a portion of one surface of the lower electrode. The phase change memory device includes a heating electrode covering at least one surface of the insulating layer and the portion of the surface of the lower electrode exposed by the pore and including a recess region. The phase change memory device includes a phase change layer formed on the heating electrode and filled into the recess region and an upper electrode stacked on the phase change layer.

At least one or more pore may be formed on a surface of the lower electrode.

The heating electrode may surround at least one surface of the phase change layer. The heating electrode may have a uniform thickness. The heating electrode may thicken toward a lower portion of a sidewall of the pore. The heating electrode may be formed of a combination of an electrode having a uniform thickness with an electrode thickening toward a lower portion of the pore.

According to another aspect of the present invention, there is provided a method of fabricating a phase change memory device. A lower electrode is formed. Next, an insulating layer is formed to cover at least one surface of the lower electrode. The insulating layer is etched to form a pore exposing a portion of a surface of the lower electrode. A heating electrode covering at least one sidewall of the pore is formed through a blanket method to form a recess region. The recess region is filled up and the phase change layer is formed.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional phase change memory device;

FIGS. 2 through 5 are cross-sectional views illustrating a method of fabricating a phase change memory device according to an embodiment of the present invention;

FIGS. 6 and 7 are cross-sectional views illustrating a method of fabricating a phase change memory device according to another embodiment of the present invention; and

FIGS. 8 and 9 are cross-sectional views illustrating a method of fabricating a phase change memory device according to another embodiment of the present invention.

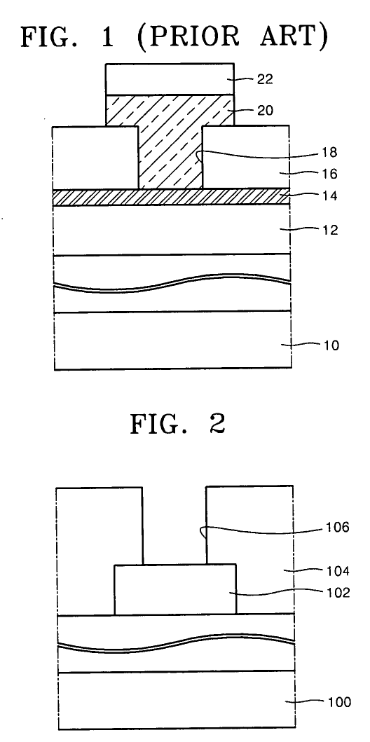

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thickness of layers and regions are exaggerated for clarity. It will also be understood that when a layer is referred to as being on another layer or substrate, it can be directly on the other layer or substrate, or intervening layers may also be present. Like reference numerals in the drawings denote like elements.

A phase change memory device according to embodiments of the present invention will provide various ways to reduce power consumption. That is, the present invention provides a structure whereby a heating electrode surrounds a phase change region in which a phase change occurs in a phase change layer in order to limit heat necessary for a phase change. Since the phase change memory device uses heat generated from a contact area of the phase change layer and the heating electrode, maximizing the contact area and limiting heat can greatly reduce power consumption.

As a general method of maximizing the contact area, the heating electrode surrounds the phase change region. This method can be implemented by the following embodiments.

### Embodiment 1

FIGS. 2 through 5 are cross-sectional views illustrating a method of fabricating a phase change memory device according to an embodiment of the present invention. The cross-sectional views of FIGS. 2 through 5 represent a single unit cell for convenience.

Referring to FIG. 2, a lower electrode 102 is formed on a substrate 100. An insulating layer or a fabric may be formed between the substrate 100 and the lower electrode 102. For example, phosphorus or arsenic may be doped on a silicon layer at approximately 10¹⁸ to 10¹⁹/cm⁻³ to form the lower electrode 102. In some cases, a metal conductive layer such as aluminum or tungsten may be patterned by means of a conventional method to form the lower electrode 102.

Next, an insulating layer 104 is formed including a pore 106 which is an opening exposing a portion of an upper surface of the lower electrode 102. The insulating layer 104 may be formed of a material having low thermal conductivity. For example, the insulating layer 104 may be at least one layer selected from a silicon oxide layer, a silicon nitride layer, and a silicon oxide/nitride layer. The pore 106 may be formed by a conventional photolithography process, but is not limited thereto and may be formed by various other methods. A thickness of the insulating layer 104 determines a depth of the pore 106, and the pore 106 has a significant effect on a phase change region. Therefore, the insulating layer 106 should be formed thick enough for a phase change region. Although FIG. 2 illustrates that the pore 106 is formed on top of the lower electrode 102, another pore 106 can be formed on a lateral side of the lower electrode 102 and the number of pores 106 can vary.

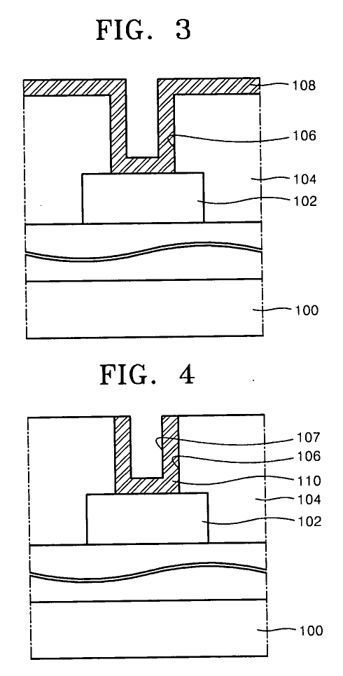

Referring to FIG. 3, a heating electrode material layer 108 is formed on the overall substrate 100 including the insulating layer 104 by using a blanket method. That is, the heating electrode material layer 108 covers a side that is exposed by the pore 106 and an upper surface of the insulating layer 104 and an upper surface of the lower electrode 102 by using a blanket method. The heating electrode material layer 108 may be formed of any material that emits Joule heat by receiving a current. The heating electrode material layer 108 has a predetermined thickness, and may form a region into which a phase change material can be filled in the pore 106.

Referring to FIG. 4, the heating electrode material layer 108 is removed to expose the upper surface of the insulating layer 104. The heating electrode material layer 108 may be removed using a planarization process such as a chemical mechanical polishing (CMP) process, etc. According to this, a first heating electrode 110 that is limited by the pore 106 and has a recess region 107 is formed. That is, the first heating electrode 110 covers sidewalls of the pore 106 and at least a portion of the upper surface of the lower electrode 102. The first heating electrode 110 is not formed outside the pore 106 or on the upper surface of the insulating layer 104. The first heating electrode 110 according to an embodiment of the present invention has a uniform thickness and a “U” shape.

In an embodiment of the present invention, the first heating electrode 110 is formed not by a photolithography process but by a planarization process. As the phase change memory device is highly integrated and shrunk, if the heating electrode 110 is patterned by using the photolithography process, the misalignment is likely to occur in the photolithography process used to form the heating electrode 110. When such a misalignment occurs, there may be a difference in a contact area of the phase change layer and the heating electrode between unit cells of the phase change memory device. A big difference in power consumption, which occurs between the unit cells of the phase change memory device, may lower a yield rate when the phase change memory devices are fabricated in large quantities on the substrate.

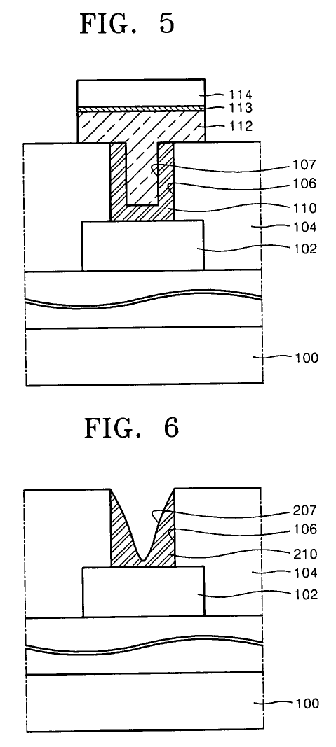

Referring to FIG. 5, a phase change layer 112 that is formed so as to fill up the recess region 107 is patterned. An upper electrode 114 may be formed with the same sidewall profile as the phase change layer 112 on the phase change layer 112. That is, the phase change layer 112 and the upper electrode 114 may be patterned at the same time through a conventional method. According to this, the heating electrode 110 that covers at least one sidewall of the pore 106 surrounds at least one surface of the phase change layer 112.

The phase change layer 112 is formed of a material capable of changing into a crystal state and an amorphous state according to a change in the applied Joule heat. For example, the phase change layer 112 may be formed of chalcogenide including at least one element of group VI of the periodic table. Specifically, the phase change layer 112 may be formed of at least one material selected from GaSb, InSb, InSe, Sb₂Te, GeTe, Ge₂Sb₂Te₅, InSbTe, GaSeTe, SnSb₂Te, InSbGe, AgInSbTe, (GeSn)SbTe, GeSb(SeTe), and Te₈₁Gel₅Sb₂S₂. The upper electrode 114 may be formed of a conductive metal such as aluminum or tungsten.

In some cases, at least one barrier layer 113 may be further formed between the phase change layer 112 and the upper electrode 114. The barrier layer 113 may include at least one layer selected from a Ti layer, a TiAlN layer, a TiSiN layer, and a TiN layer.

### Embodiment 2

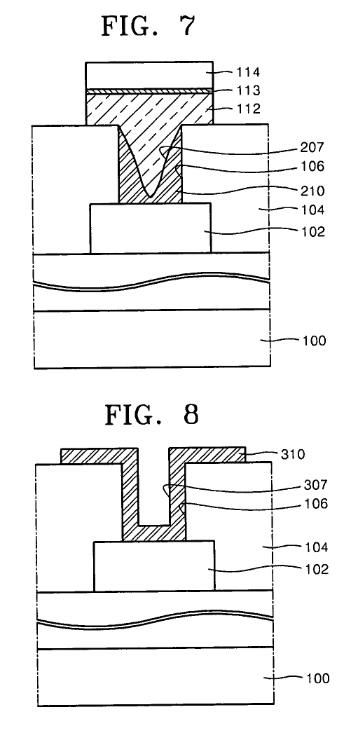

FIGS. 6 and 7 are cross-sectional views illustrating a method of fabricating a phase change memory device according to another embodiment of the present invention. The cross-sectional view of FIGS. 6 and 7 represent a single unit cell for convenience. The method of forming a lower electrode 102, an insulating layer 104, and a heating electrode material layer 108 is identical with the embodiment illustrated in FIGS. 2 and 3.

Referring FIG. 6, the heating electrode material layer 108 illustrated in FIG. 3 may be etched by using a spacer etching method. Accordingly, a second heating electrode 210 that is limited by a pore 106 and has a recess region 207 is formed. The second heating electrode 210 covers at least a portion of a sidewall of the pore 106 and at least a portion of an upper surface of the lower electrode 102. The second heating electrode 210 is not formed outside the pore 106 or on an upper surface of the insulating layer 104.

However, the second heating electrode 210 according to another embodiment illustrated in FIGS. 6 and 7 is different from an embodiment illustrated in FIGS. 2 through 5 in that the thickness of the second heating electrode 210 changes along a sidewall. That is, the second heating electrode 210 has a thickness thickens toward a lower portion of the sidewall. The heating electrode has different resistance values according to its shape. That is, the second heating electrode 210 has a different resistance value from the first heating electrode 110.

In particular, the second heating electrode 210 is formed not by a photolithography process but by a spacer etching method, as is the first heating electrode 110 according to an embodiment illustrated in FIGS. 2 through 5, and thus is not misaligned. Therefore, a difference in a contact area of the phase change layer and the heating electrode can be decreased between unit cells of the phase change memory device, thereby decreasing a difference in power consumption between the unit cells of the phase change memory device.

Referring to FIG. 7, a phase change layer 112 filling up the recess region 207 is patterned. An upper electrode 114 may be formed with the same sidewall profile as the phase change layer 112 on the phase change layer 112. That is, the phase change layer 112 and the upper electrode 114 may be patterned at the same time through a conventional method. Accordingly, the heating electrode 210 that covers at least one sidewall of the pore 106 surrounds at least one surface of the phase change layer 112.

The phase change layer 112 is formed of a material capable of changing into a crystal state and an amorphous state according to a change in the applied Joule heat. For example, the phase change layer 112 may be formed of chalcogenide including at least one element of group VI of the periodic table. Specifically, the phase change layer 112 may be formed of at least one material selected from GaSb, InSb, InSe, Sb₂Te, GeTe, Ge₂Sb₂Te₅, InSbTe, GaSeTe, SnSb₂Te, InSbGe, AgInSbTe, (GeSn)SbTe, GeSb(SeTe), and Te₈₁Gel₅Sb₂S₂. The upper electrode 114 may be formed of a metal conductive material such as aluminum or tungsten.

In some cases, at least one barrier layer 113 may be further formed between the phase change layer 112 and the upper electrode 114. The barrier layer 113 may include at least one layer selected from a Ti layer, a TiAlN layer, a TiSiN layer, and a TiN layer.

A heating electrode of the phase change memory device of the present invention may be formed of a combination of the first heating electrode 110 having a uniform thickness with the second heating electrode 210 thickens toward the lower portion of the pore 106. In some cases, heating electrodes of various shapes may be formed. For example, the heating electrode may be thinner at a sidewall than at the bottom of the pore 106. Therefore, the heating electrode of the phase change memory device according to embodiments of the present invention may use combinations of various shapes of the heating electrodes that have various resistance values.

### Embodiment 3

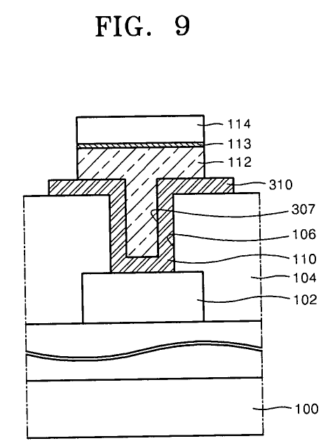

FIGS. 8 and 9 are cross-sectional views illustrating a method of fabricating a phase change memory device according to another embodiment of the present invention. The cross-sectional view of FIGS. 8 and 9 represent a single unit cell for convenience. The method of fabricating a lower electrode 102, an insulating layer 104, and a heating electrode material layer 108 is identical with an embodiment in FIGS. 2 and 3.

Referring to FIG. 8, the heating electrode material layer 108 illustrated in FIG. 3 is patterned by using a photolithography process. Accordingly, a third heating electrode 310 that is limited by a pore 106 and has a recess region 307 is formed. The third heating electrode 310 covers at least a portion of a sidewall of the pore 106 and at least a portion of an upper surface of the lower electrode 102.

Referring to FIG. 9, a phase change layer 112 that is formed so as to fill up the recess region 307 is patterned. An upper electrode 114 may be formed with the same sidewall profile as the phase change layer 112 on the phase change layer 112. That is, the phase change layer 112 and the upper electrode 114 may be patterned at the same time by using a conventional method. According to this, the heating electrode 310 that covers at least one sidewall of the pore 106 surrounds at least one surface of the phase change layer 112.

The phase change layer 112 is formed of a material capable of changing into a crystal state and an amorphous state according to a change in the applied Joule heat. For example, the phase change layer 112 may be formed of chalcogenide including at least one element of group VI of the periodic table. Specifically, the phase change layer 112 may be formed of at least one material selected from GaSb, InSb, InSe, Sb₂Te, GeTe, Ge₂Sb₂Te₅, InSbTe, GaSeTe, SnSb₂Te, InSbGe, AgInSbTe, (GeSn)SbTe, GeSb(SeTe), and Te₈₁Gel₅Sb₂S₂. The upper electrode 114 may be formed of a metal conductive material such as aluminum or tungsten.

In some cases, at least one barrier layer 113 may be further formed between the phase change layer 112 and the upper electrode 114. The barrier layer 113 may include at least one layer selected from a Ti layer, a TiAlN layer, a TiSiN layer, and a TiN layer.

According to the phase change memory device and the method of fabricating the same of the present invention, since at least a portion of the phase change layer is surrounded with the heating electrode covering at least a sidewall of the pore, a contact area of the phase change layer and the heating electrode may be maximized to greatly reduce power consumption.

In addition, according to the present invention, when the heating electrode is formed not by the photolithography process but by the planarization process or the spacer etching process, the misalignment of the heating electrode can be prevented. Accordingly, a difference in a contact area of the phase change layer and the heating electrode may be decreased between the unit cells of the phase change memory device, thereby decreasing a difference in power consumption between the unit cells of the phase change memory device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A phase change memory device comprising:
an insulating layer covering at least one surface of a lower electrode and including a pore that exposes a portion of the surface of the lower electrode;
a heating electrode covering at least one surface of the insulating layer and the portion of the surface of the lower electrode exposed by the pore, and the heating electrode including a recess region;
a phase change layer formed on the heating electrode and filled into the recess region; and
an upper electrode stacked on the phase change layer.

2. The phase change memory device of claim 1, wherein the insulating layer includes a plurality of pores formed on a surface of the lower electrode.

3. The phase change memory device of claim 1, wherein the heating electrode surrounds at least one surface of the phase change layer.

4. The phase change memory device of claim 1, wherein the heating electrode has a uniform thickness.

5. The phase change memory device of claim 1, wherein the heating electrode thickens toward a lower portion of a sidewall of the pore.

6. The phase change memory device of claim 1, wherein the heating electrode is formed of a combination of an electrode having a uniform thickness with an electrode thickening toward a lower portion of the pore.

7. The phase change memory device of claim 1, wherein at least one or more barrier layers are formed between the phase change layer and the upper electrode, and the barrier layer is at least one layer selected from a Ti layer, a TiAlN layer, a TiSiN layer, and a TiN layer.

8. A phase change memory device comprising:
an insulating layer including a pore that exposes a portion of a surface of a lower electrode;
a heating electrode covering at least one sidewall of the insulating layer and the portion of the surface of the lower electrode exposed by the pore, and the heating electrode including a recess region;
a phase change layer formed on the heating electrode and filled into the recess region; and
an upper electrode stacked on the phase change layer,
wherein at least one surface of the phase change layer is surrounded with the heating electrode that covers at least one sidewall of the insulating layer exposed by the pore.

9. A method of fabricating a phase change memory device, the method comprising:
forming a lower electrode;
forming an insulating layer covering at least one surface of the lower electrode;
etching the insulating layer to form a pore exposing a portion of a surface of the lower electrode;
forming a heating electrode that covers at least one sidewall of the pore and has a recess region; and
forming a phase change layer that fills up the recess region and is stacked on the heating electrode.

10. The method of claim 9, wherein the heating electrode surrounds at least one surface of the phase change layer.

11. The method of claim 9, wherein the heating electrode has a uniform thickness.

12. The method of claim 9, wherein the heating electrode thickens toward a lower portion of a sidewall of the pore.

13. The method of claim 9, wherein the heating electrode is formed of a combination of an electrode having a uniform thickness with an electrode thickening toward a lower portion of the pore.

14. The method of claim 9, wherein a heating electrode material layer is formed on the overall substrate including the insulating layer by using a blanket method and the heating electrode material layer is removed so that an upper surface of the insulating layer is exposed to form the heating electrode.

15. The method of claim 9, wherein a heating electrode material layer is formed on the overall substrate including the insulating layer by using a blanket method and the heating electrode material layer is etched by using a spacer etching method to form the heating electrode.

16. A method of fabricating a phase change memory device, the method comprising:
forming a lower electrode;
forming an insulating layer covering at least one surface of the lower electrode;
etching the insulating layer to form a pore exposing a portion of a surface of the lower electrode;
forming a heating electrode that covers at least one sidewall of the pore and has a recess region; and
forming a phase change layer that fills up the recess region and is stacked on the heating electrode,
wherein at least one surface of the phase change layer is surrounded with the heating electrode that covers at least one sidewall of the insulating layer exposed by the pore.
